(19) United States
(12) Patent Application Publication
(10) Pub. No.: US 2012/0269963 A1
(43) Pub. Date: Oct. 25, 2012

(54) FORMULATIONS FOR PRODUCING ROADWAY MARKINGS WITH ADHESION ON DRY AND DAMP CONCRETE

(75) Inventors: Peter Neugebauer, Limburg (DE); Alexander Klein, Gau-Algesheim (DE); Heike Heeb, Bickenbach (DE); Klaus Ramesch, Hainburg (DE); Sybille Scholl, Rodenbach (DE); Ingrid Kizewski, Hanau (DE)

(73) Assignee: Evonik Roehm GmbH, Darmstadt (DE)

(21) Appl. No.: 13/517,186

(22) PCT Filed: Dec. 15, 2010
(86) PCT No.: PCT/EP10/69681

§ 371 Date: Jun. 19, 2012

(30) Foreign Application Priority Data
Jan. 26, 2010 (DE) 10 2010 001 217.3
Feb. 18, 2010 (DE) 10 2010 002 123.7

(51) Int. Cl. C09D 133/10; B05D 7/00; C08K 3/22

(52) U.S. Cl. 427/136; 523/172

(57) ABSTRACT

The invention comprises a novel formulation for marking roadways, consisting of different subsurfaces such as, for example, concrete. The invention also relates to a formulation for marking roadways, which can be applied both to damp and to dry surfaces.

### FIELD OF THE INVENTION

The present invention comprises a novel formulation for marking trafficways composed of various substrates such as concrete. The present invention further relates to a formulation for marking trafficways, which can be applied to either damp or dry surfaces.

Modern trafficway markings are subject to many requirements. Firstly, these systems are expected to be easy to apply to the road surface and at the same time to provide good shelf life and a long lifetime of the marking. In the prior art for applying trafficway markings it is necessary, prior to application, that the trafficway section to be marked is completely dried. This makes the marking process, especially for roads, complicated and weather-dependent. Marking is mostly completely impossible with established systems in wet conditions, for example after rain.

Concrete is moreover a poor substrate for most marking systems. In comparison with asphalt substrates, there is generally a marked reduction in adhesion and therefore in the lifetime of the marking. In the prior art, therefore, concrete first has to be coated with a primer before the actual roadmarking can be applied.

### PRIOR ART

Examples of systems currently used as trafficway marking materials are solvent-based paints, water-based paints, thermoplastic paints, paints based on reactive resins, and also prefabricated adhesive tapes. A disadvantage of the latter is that they are complicated to produce and to apply. Because long lifetime of the marking is desired, there is also only a restricted amount of freedom available with regard to the design of the marking, for example with glass beads.

EP 0 705 307 describes a primer system for adhesive tapes of this type; this system can also explicitly be used on damp substrates. The drying effect derives mainly from solvents which are present in the primers and which form an azeotrope with water and thus, during evaporation, remove small amounts of water from the surface. This process has not only the disadvantages inherent to this type of adhesive tape but also other disadvantages: the amount of water that can be removed is restricted, and there is therefore a certain level of dampness that must not be exceeded. A waiting time of at least 20 minutes is also necessary between application of the primer and application of the adhesive tape.

Thermoplastic coatings such as those described in DE 24 07 159, applied in the molten state to the trafficway surface, can per se contribute to drying of the substrate simply by virtue of the temperature of, for example, 180° C. Their use has the great disadvantage of an additional step, in that the product must first be melted before it can be applied. Not only is this potentially dangerous because of the high temperature, but thermoplastic systems per se have relatively high susceptibility to abrasion and relatively low heat resistance. Thermoplastic systems often have markedly shorter lifetime than systems which are, for example, based on reactive resins and react with crosslinking.

Aqueous systems in particular, for example as described in EP 1 505 127, EP 1 162 237 and EP 2 077 305, are very disadvantageous in relation to drying rate. The drying time of this type of system is markedly longer. Although dispersibility in water is inevitably associated with capability for use on damp substrates, the use either of desiccants or of moisture-crosslinking components is necessarily excluded in the systems, and there is therefore significant restriction of the freedom available for formulating this type of system and therefore for optimizing adhesion on damp substrates.

The problem of low drying rate can, as described in US 2007/0148357, be mitigated by adding cosolvents. However, this does not necessarily improve adhesion on difficult substrates.

All of the trafficway marking systems described comprise titanium dioxide as pigment and calcium carbonate as filler. However, a disadvantage of titanium dioxide is that it is relatively expensive and therefore that trafficway markings with particularly high whiteness, which is desirable in traffic engineering, become uneconomic.

### OBJECT

An object of the present invention is to provide a novel formulation for marking trafficway surfaces which can be applied by way of example to concrete without a primer and which, after drying, has good adhesion properties.

Another object consists in providing a novel formulation for trafficway marking which can be applied to both damp and dry concrete.

A particular object consists in providing a reactive resin which, in comparison with the prior art, can give trafficway markings, for example on concrete, which have longer lifetime or at least exactly the same lifetime and have good retroreflection properties, have good daytime and nighttime visibility, have high, stable whiteness, and have good grip properties, even when a trafficway is wet.

The trafficway marking produced with the novel formulation is moreover intended to have long life, to be easy to apply, to be flexible in formulation, to have good shelf life, and to permit passage of traffic soon after application.

Other objects not explicitly mentioned will be apparent from the entirety of the description, claims and examples below.

### ACHIEVEMENT OF OBJECT

The objects are achieved by providing a novel trafficway marking system, and more precisely by providing a novel flexible (meth)acrylate-based cold plastic.

In particular, the objects were achieved by providing a novel formulation which can be used as cold plastic and which comprises at least 1% by weight, preferably at least 2.5% by weight, particularly preferably at least 5% by weight, of calcium oxide. The calcium oxide is added as a constituent of an inorganic mixture to the formulation. Said inorganic mixture is composed of at least 30% by weight, preferably at least 40% by weight, particularly preferably at least 50% by weight, of calcium oxide. The calcium oxide in the inorganic mixture is not necessarily pure calcium oxide, but can also be in a bound form, e.g. as tricalcium silicate (3 CaO.SiO₂), as dicalcium silicate (2 CaO.SiO₂), as tricalcium aluminate (3 CaO.Al₂O₃) or as tetracalcium aluminate ferrite (4 CaO.Al₂O₃.Fe₂O₃).

The inorganic mixtures can comprise, alongside calcium oxide or bound calcium oxide, inter alia up to 50% by weight of silicon dioxide, up to 20% by weight of aluminum oxide and up to 10% by weight of iron oxides. The proportion of iron oxide is however preferably smaller than 1% by weight, particularly preferably smaller than 0.5% by weight and with particular preference smaller than 0.1% by weight. Relatively small amounts of sulfates can moreover be present, e.g. calcium sulfate, iron sulfate or aluminum sulfate.

The inorganic mixture can in particular involve quicklime, preferably light-colored quicklime, or cement, particularly Portland cement. In one very particularly preferred embodiment, the inorganic mixture involves white Portland cement with iron oxide content smaller than 0.5% by weight. White Portland cement has the particular advantage of light color, thus reducing the amount of pigment addition required when, for example, the cold plastic is used.

Surprisingly, it has been found that this type of formulation, used as cold plastic for trafficway marking, has good adhesion to concrete.

Surprisingly, it has moreover been found that the calcium oxide permits marking of damp or even wet concrete trafficway surfaces. The calcium oxide is moreover unlike the calcium carbonate used in the prior art in that it also contributes to the robustness of the trafficway marking and therefore to its lifetime.

The calcium oxide is moreover a suitable material for increasing the whiteness of the cold plastic, in particular if it is introduced in the form of a white Portland cement or of a quicklime into the formulation. This permits reduction of the concentration of other pigments which are generally more expensive and do not contribute to adhesion, for example titanium dioxide.

Cold plastics for trafficway marking in the prior art comprise fine mineral fillers and coarse fillers. These materials have antiskid properties and are therefore in particular added to improve grip. Coarse fillers used comprise quartzes, cristobalites, corundums and aluminum silicates. Fine fillers used come from the group of the alkaline earth metal carbonates, e.g. calcium carbonate, powdered and other quartzes, precipitated and fumed silicas, pigments and cristobalites. In the inventive design of this type of cold plastic, one of these fillers or all of the fillers can be replaced by calcium oxide or the inorganic mixture comprising calcium oxide. The calcium oxide or the cement, preferably white Portland cement, has exactly the same suitability as filler, without any significant discernible reduction of antiskid properties.

A particular object achieved, in comparison with the prior art, through addition of calcium oxide to standard roadmarking systems, for example to cold plastics, is a wider range of use on various, dry or wet substrates together with very good optical properties, such as whiteness, daytime and nighttime visibility, reflection properties and long lifetime: a particular achievement of the present invention is that the inventive modification permits use of a large number of traditional roadmarking systems on wet concrete substrates without primer and without pretreatment of the surface.

These cold plastics are generally based on reactive resins, composed of crosslinking agents, for example dimethacrylates, of monomers, generally (meth)acrylates and/or components copolymerizable with (meth)acrylates, of binders or prepolymers, generally polyester- and/or poly(meth)acrylate-based, of an accelerator and of optional urethane (meth)acrylates. Other auxiliaries or additives can moreover be present, examples being antifoams, stabilizers, inhibitors, chain-transfer agents or waxes.

These reactive resins are used as a basis for formulations which make up one of optionally two to three components of the entire cold plastic. Said formulations generally comprise the following components alongside the reactive resins: one or more initiators, inorganic and/or organic pigments, for example titanium dioxide, and other mineral fillers. There can moreover be other additives present, for example auxiliaries for thixotropic properties, for rheological properties and/or for dispersion properties.

In particular, the cold plastics of the invention comprise the following components: from 15% by weight to 45% by weight of a reactive resin, from 1% by weight to 5% by weight of a mixture comprising one or more initiators, from 2% by weight to 40% by weight of said inorganic mixture comprising calcium oxide, from 0% by weight to 15% by weight of an inorganic pigment, preferably titanium dioxide, and from 20% by weight to 60% by weight of other mineral fillers.

The reactive resin here preferably comprises the following ingredients: from 5% by weight to 30% by weight of dimethacrylates, from 30% by weight to 70% by weight of (meth)acrylates and/or components copolymerizable with (meth)acrylates, from 0% by weight to 40% by weight of urethane (meth)acrylates, from 15% by weight to 35% by weight of poly(meth)acrylates and/or polyesters, from 0% by weight to 5% by weight of accelerators and optionally other auxiliaries. The initiator preferably involves dilauroyl peroxide and/or dibenzoyl peroxide. The accelerator preferably involves a tertiary, aromatically substituted amine.

In an alternative embodiment, the peroxide is a constituent of the reactive resin and the accelerator is not a constituent of the reactive resin, but instead is a constituent of a separate component of the cold plastic.

This component can also comprise other auxiliaries, such as wetting agents and/or dispersing agents, a filler with grip (antiskid) properties, and antisedimentation agents. The glass beads which are added to improve reflection can also be already present in this component of the cold plastic. As an alternative, these can also be a constituent of the second component, and in a preferred method, if the mechanism of application of the trafficway marking is appropriate, glass beads can be applied as third component. In this procedure, for example used with modern marking vehicles with a second nozzle, the beads are sprayed onto the first two components directly after application thereof. This procedure has the advantage that the portion of the glass beads wetted by the constituents of the other two components is only the portion embedded into the marking matrix, and ideal reflection properties are obtained. However, an important factor very particularly when this technology is used is particularly good embedding of the glass beads and correspondingly good adhesion of the marking matrix or of the trafficway marking formulation to the surface of the glass beads. The properties required from a roadmarking material are regulated more precisely in DIN EN 1436.

The second component of the cold plastic comprises the initiator. Particular polymerization initiators used are peroxides or azo compounds. It can sometimes be advantageous to use a mixture of various initiators. It is preferable to use, as free-radical initiator, halogen-free peroxides, such as dilauroyl peroxide, dibenzoyl peroxide, tert-butyl peroctoate, di(tert-butyl) peroxide (DTBP), di(tert-amyl) peroxide (DTAP), tert-butylperoxy 2-ethylhexyl carbonate (TBPEHC) and other peroxides that decompose at high temperature. The peroxides can also be used in phlegmatized form. For reactive resins for use by way of example for trafficway markings, particular preference is given to dilauroyl peroxide or dibenzoyl peroxide. The peroxide is generally in the second component, admixed with a diluent, for example with a phthalate, such as dibutyl phthalate, with an oil or with any other plasticizer. The cold plastic of the invention, being the entirety of the first and second, and also optionally the third, components, comprises from 0.1% by weight to 7% by weight, preferably from 0.5% by weight to 6% by weight and very particularly preferably from 1% by weight to 5% by weight, of the initiator or of the mixture made from the initiator and from the diluent.

A particular embodiment of a redox initiator system for reactive resins is the combination of peroxides and accelerators, in particular amines. Examples that may be mentioned of said amines are tertiary aromatically substituted amines, such as in particular N,N-dimethyl-p-toluidine, N,N-bis(2-hydroxyethyl)-p-toluidine or N,N-bis-(2-hydroxypropyl)-p-toluidine. The reactive resin of the invention can comprise up to 7% by weight, preferably up to 5% by weight and very particularly preferably up to 3% by weight, of an accelerator.

In an alternative embodiment of a 3C system, the accelerator is present in the second component, for example in a diluent, and the initiator, for example the peroxide, is a constituent of the reactive resin of the invention. The third component involves glass beads and possibly any necessary adhesion promoters. The diameters of the commercially available glass beads used are from 10 μm to 2000 μm, preferably from 50 μm to 800 μm.

The crosslinking agents, in particular polyfunctional methacrylates, such as allyl (meth)acrylate, are a significant constituent of the reactive resin of the invention. Particular preference is given to di- or tri-(meth)acrylates, such as 1,4-butanediol di(meth)acrylate, tetraethylene glycol di(meth)acrylate, triethylene glycol di(meth)acrylate or trimethylolpropanetri(meth)acrylate.

Urethane (meth)acrylates are often another constituent of reactive resins for roadmarking. These are compounds which have (meth)acrylate functionalities linked to one another by way of urethane groups. They can be obtained through the reaction of hydroxyalkyl (meth)acrylates with polyisocyanates and polyoxyalkylenes which have at least two hydroxy functionalities. Other compounds that can be used instead of hydroxyalkyl (meth)acrylates are esters of (meth)acrylic acid with oxiranes, such as ethylene oxide or propylene oxide, or with corresponding oligo- or polyoxiranes. An overview by way of example of urethane (meth)acrylates with functionality greater than 2 is found in DE 199 02 685. A commercially available example produced from polyols, isocyanates and hydroxyl-functional methacrylates is EBECRYL 210-5129 from UCB Chemicals. Urethane (meth)acrylates in a reactive resin increase flexibility, ultimate tensile strength and tensile strain at break without any increase in temperature dependency.

In a particular embodiment, the cold plastic also comprises an adhesion promoter. The adhesion promoter used can comprise any of the functional compounds which can interact with concrete and/or calcium oxide and/or cement. The adhesion promoter is preferably introduced into the cold plastic in situ before application thereof. The adhesion promoter here can optionally be diluted in pure reactive resin and dispersed before addition to the cold plastic, in order to achieve greater ease of metering and greater dispersibility. The reactive resin here comprises from 0.1% by weight to 20% by weight of adhesion promoter, preferably from 1% by weight to 5% by weight. Preferred adhesion promoters used are (meth)acrylic acid, silyl-functional (meth)acrylates, the phosphates of a hydroxyl-functional (meth)acrylate or blends made from (meth)acrylates and from polyisocyanate prepolymers. Preferred examples of blends made from (meth)acrylates and from polyisocyanate prepolymers are Degadur® BE additive and Degadur® i-component, each from Evonik Rohm GmbH. A preferred example of phosphates of hydroxyl-functional (meth)acrylates is methacryloxyloxyethyl phosphate, marketed as adhesion promoter HP by Evonik Rohm GmbH. Preferred example of a silyl-functional (meth)acrylate is Dynasylan® MEMO from Evonik Degussa GmbH. This involves 3-methacryloxypropyltrimethoxysilane.

In another alternative embodiment with particularly good shelf life, the cold plastic is stored in two separate components, mixed with one another shortly prior to application. In this embodiment, the first component comprises adhesion promoter and the calcium oxide, and the second component comprises other fillers and the pigments. Reactive resin, additives, reflective beads and accelerator can be present here in one of the two components or in both. The initiator, in all cases added directly prior to application, is again added separately in this additional embodiment. In the event that one of the two components comprises no accelerator, the accelerator must be added into at least one of the two components or into a mixture of these.

In this embodiment, the cold plastic is therefore stored as 3-component system and mixed only prior to application. The first component here comprises the calcium oxide and optionally the adhesion promoter. The second component comprises the other fillers and the pigments. The third component comprises the initiator not present in the first two components. All of the other constituents of the cold plastic can be present in the first and/or second component. It is preferable that all of the other constituents, such as additives or the reactive resin, are present in the same ratio to one another in the first and in the second component.

The monomers present in the reactive resin involve compounds selected from the group of the (meth)acrylates, for example alkyl (meth)acrylates of straight-chain, branched or cycloaliphatic alcohols having from 1 to 40 carbon atoms, examples being methyl (meth)acrylate, ethyl (meth)acrylate, n-butyl (meth)acrylate, 2-ethylhexyl (meth)acrylate, stearyl (meth)acrylate, lauryl (meth)acrylate; aryl (meth)acrylates, for example benzyl (meth)acrylate; mono(meth)acrylates of ethers, of polyethylene glycols, of polypropylene glycols, or mixtures of these having from 5 to 80 carbon atoms, for example tetrahydrofurfuryl (meth)acrylate, methoxy(m)ethoxyethyl (meth)acrylate, benzyloxymethyl (meth)acrylate, 1-ethoxybutyl (meth)acrylate, 1-ethoxyethyl (meth)acrylate, ethoxymethyl (meth)acrylate, poly(ethylene glycol)methyl ether (meth)acrylate and poly(propylene glycol) methyl ether (meth) acrylate.

Other suitable constituents of monomer mixtures are additional monomers having another functional group, for example α,β-unsaturated mono- or dicarboxylic acids, e.g. acrylic acid, methacrylic acid or itaconic acid; esters of acrylic acid or methacrylic acid with dihydric alcohols, for example hydroxyethyl (meth)acrylate or hydroxypropyl (meth)acrylate; acrylamide or methacrylamide; or dimethylaminoethyl (meth)acrylate. Examples of other suitable constituents of monomer mixtures are glycidyl (meth)acrylate and silyl-functional (meth) acrylates.

The monomer mixtures can also comprise, alongside the (meth)acrylates described above, other unsaturated monomers which are copolymerizable by means of free-radical polymerization with the abovementioned (meth)acrylates. Among these are inter alia 1-alkenes and styrenes. The detailed selection of the proportion and constitution of the poly(meth)acrylate advantageously depends on the desired technical function. The monomer content of the reactive resin here is from 20% by weight to 50% by weight, preferably from 30% by weight to 40% by weight.

The systems known as MO-PO systems also comprise, alongside the monomers listed, polymers which for the purposes of this patent are termed prepolymer in order to render them more easily distinguishable, preferably polyesters or poly(meth)acrylates. These are used to achieve improvement in polymerization properties, mechanical properties, and adhesion to the substrate, and also with a view to the optical requirements placed upon the resins. The proportion of prepolymer in the reactive resin here is from 10% by weight to 40% by weight, preferably from 15% by weight to 25% by weight. Not only the polyesters but also the poly(meth)acrylates can have additional functional groups for coupling purposes or for purposes of copolymerization in the crosslinking reaction, for example taking the form of double bonds. However, it is preferable that, with a view to better stability of color of the trafficway marking, the prepolymers have no double bonds. Said poly(meth)acrylates are generally composed of monomers identical with those previously listed in relation to the monomers in the resin system. They can be obtained by solution polymerization, emulsion polymerization, suspension polymerization, bulk polymerization, or precipitation polymerization, and are added in pure form to the system.

Said polyesters are obtained in undiluted form by polycondensation or ring-opening polymerization, and are composed of the units known for these uses.

Other auxiliaries and additives that can be used are chain-transfer agents, plasticizers, paraffins, stabilizers, inhibitors, waxes, and/or oils.

The paraffins are added in order to prevent inhibition of the polymerization reaction by the oxygen in air. To this end it is possible to use a plurality of paraffins with different melting points, in different concentrations.

Chain-transfer agents used can comprise any of the compounds known from free-radical polymerization reactions. It is preferable to use mercaptans, such as n-dodecyl mercaptan.

Preferred plasticizers used are esters, polyols, oils, or low-molecular-weight polyethers, or phthalates.

The following can also be added to the formulations for trafficway markings: dyes, glass beads, fine and coarse fillers, wetting agents, dispersing agents, and leveling aids, UV stabilizers, antifoams, and rheology additives. When the formulations are used in the application sector of trafficway marking or surface marking, auxiliaries and additives added preferably comprise dyes. Particular preference is given to white, red, blue, green, orange, yellow, and black inorganic pigments and to inorganic pigments providing pinkish-purple coloration. White pigment used is generally titanium dioxide. When quicklime or white Portland cement is added in the invention, the whiteness achieved is intrinsically good, and it is therefore possible to use less titanium dioxide when formulating white and colored trafficway markings. The perceived color achieved in colored roadmarkings is nevertheless good and clear.

It is equally possible to use conventional UV stabilizers. The UV stabilizers are preferably selected from the group of the benzophenone derivatives, benzotriazole derivatives, thioxanthonate derivatives, piperidinolcarboxylic ester derivatives and cinnamic ester derivatives. Compounds used from the group of the stabilizers or inhibitors are preferably substituted phenols, hydroquinone derivatives, phosphines and phosphites.

The following components can optionally also be present in formulations for trafficway marking:

wetting agents, dispersing agents and leveling aids are preferably selected from the group of the alcohols, hydrocarbons, glycol derivatives, derivatives of glycolic esters, of acetic esters and of polysiloxanes, or from the group of the polyethers, polysiloxanes, polycarboxylic acids, and saturated and unsaturated polycarboxamides.

Preferred rheology additives used are polyhydroxycarboxamides, urea derivatives, salts of unsaturated carboxylic esters, alkylammonium salts of acidic derivatives of phosphoric acid, ketoximes, amine salts of p-toluenesulfonic acid, amine salts of sulfonic acid derivatives, or else aqueous or organic solutions or mixtures of the compounds. Rheology additives that have been found to be particularly suitable are those based on fumed or precipitated, and also optionally silanized, silicas with BET surface area of from 10 to 700 m²/g.

Antifoams are preferably selected from the group of the alcohols, hydrocarbons, paraffin-based mineral oils, glycol derivatives, and derivatives of glycolic esters, of acetic esters, and of polysiloxanes.

This freedom of formulation shows that the reactive resin of the invention and the cold plastic of the invention, comprising the reactive resin, can be formulated, and can accept additives, in exactly the same way as a traditional cold plastic of the prior art. With this, the following are also at least as good as in systems of the prior art: abrasion resistance, lifetime, whiteness, pigmentation, and grip.

It is also possible to optimize the system in respect of the substrate to be coated, by selection of suitable monomers, prepolymers and/or adhesion promoters. The systems of the invention can accordingly be flexibly optimized for the marking of asphalt surfaces, of concrete surfaces or of natural stone surfaces.

The cold plastics of the invention can, as a function of viscosity and constitution, be applied in the application thicknesses conventional for 2-component reactive resins, from 0.1 mm to 5 mm, by means of the traditional 2C application methods. The cold plastics (sprayable cold plastics) of the invention can be applied by means of spray methods in application thicknesses of from 0.1 to 2 mm, preferably from 0.3 to 1 mm. The cold plastics of the invention can be applied by means of extrusion methods using machines or manually, e.g. by means of a doctoring system or a trowel, at thicknesses of from 0.5 to 5 mm, preferably from 0.5 to 3 mm.

The examples given below serve to clarify the present invention, but do not restrict the invention to the features disclosed therein.

### EXAMPLES

The application tests took place on commercially available concrete paving slabs purchased from Bauzentrum RUppel GmbH, Gelnhausen, Germany. Application to dry concrete took place on paving slabs which had been stored under dry conditions for more than 3 months at room temperature. The application tests on wet concrete took place on paving slabs which had been stored in water for 4 h, and placed for about 30 seconds with the surface inclined at 45° and then blown dry with a jet of compressed air, in order to obtain a wet surface with no standing water.

The cold plastic was applied to the paving slab by means of a doctoring system at a layer thickness of 2 mm. 1 hour after application, 6 test locations of diameter 5 cm and depth 1 cm were wet-cut into the slab substrate. 2 h after application, metal tensioners were applied by adhesive bonding by means of a quick-hardening construction adhesive combination of 1 part by weight of PLEXIMON® 801 and 4 parts by weight of PLEX 7742-F from Evonik Rohm GmbH.

Bond strength at the 6 test locations is measured 3 h after application in accordance with DIN EN 1542 99 in conjunction with DAfStb-RiLi 01., by means of an F 10 Easy M2000 tensile adhesion tester from FREUNDL with a tensile force increase rate of 100 N/s at 23° C.

Measurement of pot life: after addition of the initiator in accordance with the instructions in the examples, the time required to achieve a specimen temperature of 32° C., or the time expired before the viscosity of the material makes it impossible to process, is measured.

Slump is measured by using a ruler. For this test, 40 g of the formulation are poured in the form of a single spot onto a paperboard card from a height of 10 cm. The measurement is made after complete hardening of the specimen.

Measurement of curing time: The measurement of curing time is similar to the measurement of pot life in that it begins with addition of the initiator. After slump has been measured, the time at which the surface of the specimen poured onto the paperboard card no longer has any tack in a finger test is recorded. Time measurement is stopped as soon as no further change in the surface can be discerned.

Measurement of Daniel flow value: The measurement is made by way of example with an Elcometer 2290 Daniel Flow Gauge from Elcometer. A specimen of about 150 g is controlled to a temperature of 20° C., applied to the horizontal specimen holder and smoothed. Excess material is removed here. The specimen holder is turned to a vertical position as quickly as possible and without shaking, and time recording begins at this point. After precisely one minute, the extent of flow of the specimen is read on the scale.

### Inventive Example 1/Comparative Example 1

The cold plastic of the invention in inventive example 1 and the cold plastic in comparative example 1 are produced with 20% by weight of DEGAROUTE® 465 standard reactive resin from Evonik Rohm GmbH for cold plastics, in accordance with the constitution specified in table 1. DEGAROUTE® 465 is composed of about 68% by weight of monomers, about 27% by weight of polymethacrylate binders, and about 1.6% by weight of a crosslinking agent; it also comprises an accelerator and additives, such as waxes, stabilizers and leveling aids.

Bentone 27 involves an auxiliary for thixotropic properties from Elementis GmbH. Cristobalite M 72 from Sibelco N.V. is used as coarse filler, Omyacarb 5/15 GU, from Omya GmbH, is used as fine filler, HBAC00 (50-250 μm) reflective beads from Potter Industries Inc. are used as reflectors, and TR 92 titanium dioxide from Huntsman is used as white pigment.

The reactive resin is used as initial charge at room temperature, and the following are incorporated by dispersion: a portion of the rheology additive for 5 minutes, in the next step the dispersing agent likewise for 5 minutes, and then the titanium dioxide and the fine fillers calcium carbonate and/or white Portland cement respectively for a further 10 minutes. Finally, the remainder of the dispersing agent is incorporated. A specimen is taken and the Daniel flow value is determined. 2% by weight of dibenzoyl peroxide are added, with stirring, to this cold plastic composition.

A specimen of the cold plastic is then taken and pot life and curing time, and also slump, are determined. The remainder of the cold plastic is applied with a doctoring system to give a layer of thickness 2 mm at 23° C., and tensile bond strength is measured.

Table 1 collates rheological properties and curing properties, and also bond strength of the cold plastics.

When inventive example 1 is compared with comparative example 1, improved adhesion on wet concrete is achieved with comparable rheological properties (slump and Daniel test) of the cold plastic.

Tables 1, 3 and 4 below give resin, fine and coarse fillers, pigment, glass beads and cement or quicklime, the total being 100% by weight. The amounts of the additives and adhesion promoters added (Byk 410, TEGO Dispers 670, Bentone 27, Aerosil 200, Dynasylan® MEMO) are additional percentages by weight based thereon. The formulation in table 2 is based on all of the constituents as 100% by weight.

TABLE 1

| | |
|---|---|
| Inventive | Comparative |
| example 1 | example 1 |

| | |
|---|---|
| DEGAROUTE ® 465 | 20.0% by wt. |
| Byk 410 | 0.1% by wt. |
| TEGO ® Dispers 670 | 0.1% by wt. |
| Bentone 27 | 0.1% by wt. |
| Cristobalite M 72 | 25.0% by wt. |
| HBAC00 reflective beads | 25.0% by wt. |
| Titanium dioxide (TR 92) | 10.0% by wt. |

| | | |
|---|---|---|
| White Portland cement | 20.0% by wt. | — |
| Omyacarb 15 GU | — | 20.0% by wt. |
| Pot life (2% of BPO) | 10 min | 10 min |
| Curing time (2% of BPO) | 41 min | 30 min |
| Slump | 8.5 cm | 7.5 cm |
| Daniel flow value | 13.5 | 14.0 |
| | scale points | scale points |
| Tensile bond strength | 1.6 N/mm² | no adhesion |
| on wet concrete | | |

### Inventive Example 2/Comparative Example 2

By analogy with inventive example 1, the compositions in inventive example 2 and comparative example 2 are produced in accordance with the constitutions given in table 2, but Dynasylan MEMO is also added as adhesion promoter prior to application, with stirring, and the cold plastic of the invention is stirred for a further 60 seconds.

TABLE 2

| | |
|---|---|
| Inventive | Comparative |
| example 2 | example 2 |

| | |
|---|---|
| DEGAROUTE ® 465 | 25.0% by wt. |
| Byk 410 | 0.3% by wt. |
| Disperbyk ® 163 | 0.05% by wt. |
| Aerosil 200 | 0.2% by wt. |
| Betone 27 | 0.2% by wt. |
| Cristobalite M 72 | 13.0% by wt. |
| HBAC00 reflective beads | 20.0% by wt. |
| Titanium dioxide | 10.0% by wt. |
| (TR 92) | |

| | | |
|---|---|---|
| White Portland cement | 30.0% by wt. | — |
| Omyacarb 15 GU | — | 30.0% by wt. |
| Dynasylan MEMO adhesion | 1.25% by wt. | 1.25% by wt. |
| promoter | | |
| Adhesion promoter | 5% by wt. | 5% by wt. |
| content, based on | | |
| reactive resin | | |
| composition | | |
| Tensile bond strength on | 2.3 N/mm² | no adhesion |
| wet concrete | | |

### Inventive Examples 3 and 4, and Also Comparative Example 3

The compositions in inventive examples 3 and 4 are produced with quicklime instead of white Portland cement by analogy with inventive example 2 with use of Dynasylan MEMO adhesion promoter, with the constitutions given in table 3, and are applied to dry and, respectively, wet concrete. Comparative example 3 was also applied to a dry concrete slab treated with 0.4 mm of DEGADUR 112 primer resin from Evonik Rohm GmbH. The preferred embodiment of the invention achieves better bond strengths even in comparison with application to the primed slab.

### Inventive Example 5

The composition of inventive example 5 is produced by analogy with inventive example 4 with the constitutions given in table 4.

Component 1

The reactive resin is used as initial charge at room temperature, and the following are incorporated by dispersion: a portion of the rheology additive for 5 minutes, and in the next step the quicklime for a further 10 minutes. The Dynasylan® MEMO is then added and incorporated by stirring for 5 min. Finally, the remainder of the dispersing agent is incorporated.

Component 2

The reactive resin is used as initial charge at room temperature, and the following are incorporated by dispersion: a portion of the theology additive for 5 minutes, in the next step the dispersing agent likewise for 5 minutes, and then the titanium dioxide and the fine calcium carbonate filler respectively for a further 10 minutes. Finally, the remainder of the dispersing agent is incorporated.

Specimens are taken from each of the two components, stored at 25° C. for two weeks, mixed, stirred for 10 minutes, and then visually assessed. At the same time, a specimen of inventive example 4 is stored and assessed.

The two components of the cold plastic are mixed with one another in a ratio of 1:1 and stirred for 10 minutes. 2% by weight of dibenzoyl peroxide are then added, with stirring, to this cold plastic composition. The finished composition is applied to dry and, respectively, wet concrete.

TABLE 3

| | Inventive | | Inventive | | Comparative | |
|---|---|---|---|---|---|---|
| | example 3 | | example 4 | | example 3 | |
| DEGAROUTE ® 465 | 20.0% | by wt. | 20.0% | by wt. | 20.0% | by wt. |
| Byk 410 | 0.1% | by wt. | 0.1% | by wt. | 0.1% | by wt. |
| TEGO Dispers 670 | 0.1% | by wt. | 0.25% | by wt. | 0.1% | by wt. |
| Betone 27 | 0.1% | by wt. | 0.1% | by wt. | 0.1% | by wt. |
| Cristobalite M 72 | 15% | by wt. | 25% | by wt. | 25% | by wt. |
| HBAC00 reflective | 25% | by wt. | 25% | by wt. | 25% | by wt. |
| beads | | | | | | |
| Titanium dioxide | 10% | by wt. | 10% | by wt. | 10% | by wt. |
| (TR 92) | | | | | | |
| White Portland | 30.0% | by wt. | — | | — | |
| cement | | | | | | |
| Super 40 quicklime | — | | 10% | by wt. | — | |
| Omyacarb 15 GU | — | | 10% | by wt. | 20% | by wt. |
| Dynasylan MEMO | 1.0% | by wt. | 0.6% | by wt. | — | |
| adhesion promoter | | | | | | |
| Adhesion promoter | 5% | by wt. | 3% | by wt. | — | |
| content, based on | | | | | | |
| reactive resin | | | | | | |
| composition | | | | | | |
| Pot life (2% of BPO) | 10 | min | 10 | min | 10 | min |
| Curing time (2% of | 35 | min | 30 | min | 30 | min |
| BPO) | | | | | | |
| Slump | 8.5 | cm | 9.0 | cm | 7.5 | cm |
| Daniel flow value | 13.5 | scale points | 18 | scale points | 14 | scale points |

| Tensile bond | — | — | | 3.6 | N/mm² |
|---|---|---|---|---|---|
| strength on pre- | | | | | |
| primed, dry concrete | | | | | |
| Tensile bond | — | 4.4 | N/mm² | 2.8 | N/mm² |
| strength on dry | | | | | |
| concrete | | | | | |

| | | | | | |
|---|---|---|---|---|---|
| Tensile bond | 2.5 | N/mm² | 3.3 | N/mm² | no adhesion |
| strength on wet | | | | | |
| concrete | | | | | |

TABLE 4

| Example 5 | Component 1 | Component 2 |
|---|---|---|
| DEGAROUTE ® 465 | 25.0% by wt. | 12.5% by wt. |
| Byk 410 | 0.15% by wt. | 0.06% by wt. |
| TEGO Dispers 670 | 0.05% by wt. | 0.06% by wt. |
| Betone 27 | 0.15% by wt. | 0.06% by wt. |
| Cristobalite M 72 | — | 15.5% by wt. |
| Titanium dioxide (TR | — | 6.5% by wt. |
| 92) | | |
| HBAC00 reflective beads | — | 15.5% by wt. |
| Super 40 quicklime | 25.0% by wt. | — |
| Omyacarb 15 GU | — | — |
| Dynasylan MEMO | 1.5% by wt. | — |
| adhesion promoter | | |
| Pot life (2% of BPO) | 10 | min |
| Curing time (2% of BPO) | 30 | min |
| Tensile bond strength | 4.1 | N/mm² |
| on dry concrete | | |
| Tensile bond strength | 3.4 | N/mm² |
| on wet concrete | | |

Whereas after 2 weeks the formulation of inventive example 4, with comparable constitution, has formed solids and it is no longer possible to achieve complete mixing of this formulation, the formulation of inventive example 5 has good shelf life and can be mixed successfully, after separate storage of components 1 to 3 and mixing of these prior to application.

1. A (meth)acrylate-based cold plastic, comprising:
a reactive resin;
an initiator;
a mineral filler;
a pigment; and
at least 1.0% by weight of calcium oxide.

2. The cold plastic of claim 1, comprising at least 2.5% by weight of the calcium oxide.

3. The cold plastic of claim 1, wherein the calcium oxide is added as a constituent of an inorganic mixture comprising at least 50% by weight of the calcium oxide.

4. The cold plastic of claim 3, wherein the inorganic mixture comprises quicklime, Portland cement, or another cement.

5. The cold plastic of claim 3, wherein the inorganic mixture comprises white Portland cement comprising less than 0.5% by weight of iron oxide.

6. The cold plastic of claim 1, comprising:
from 15% by weight to 45% by weight of the reactive resin;
from 1% by weight to 5% by weight of a mixture comprising the initiator;
from 2% by weight to 40% by weight of an inorganic mixture comprising the calcium oxide;
at most 15% by weight of an inorganic pigment; and
from 20% by weight to 60% by weight of at least one other mineral filler.

7. The cold plastic of claim 6, wherein the reactive resin comprises:
from 5% by weight to 30% by weight of at least one dimethacrylate;
from 30% by weight to 70% by weight of at least one (meth)acrylate, a component copolymerizable with a (meth)acrylate, or both;
from 0% by weight to 40% by weight of at least one urethane (meth)acrylate;
from 15% by weight to 35% by weight of at least one poly(meth)acrylate, a polyester, or both;
from 0% by weight to 5% by weight of at least one accelerator; and
optionally another auxiliary.

8. The cold plastic of claim 7, wherein the reactive resin further comprises from 0.1% by weight to 20% by weight of an adhesion promoter.

9. The cold plastic of claim 8, wherein the adhesion promoter comprises at least one selected from the group consisting of methacrylic acid, acrylic acid, a blend made from a (meth)acrylate, a blend made from a polyisocyanate prepolymer, and a blend made from a (meth)acrylate and a polyisocyanate prepolymer, methacryloxyloxyethyl phosphate, and 3-methacryloxypropyltrimethoxysilane.

10. The cold plastic of claim 6, wherein the initiator comprises dilauroyl peroxide, dibenzoyl peroxide, or both.

11. The cold plastic of claim 7, wherein the at least one accelerator comprises a tertiary, aromatically substituted amine.

12. The cold plastic of claim 7, wherein:
the initiator is a constituent of the reactive resin; and
the at least one accelerator is not a constituent of the reactive resin, but instead is a constituent of a separate component in the cold plastic.

13. A marking method, comprising coating a concrete surface or any other road surface with the cold plastic of claim 1.

14. The marking method of claim 13, wherein the cold plastic is applied by a spray method or extrusion method to the concrete surface or to an asphalt surface.

15. The cold plastic of claim 1, which is suitable for marking trafficways.

16. The cold plastic of claim 2, wherein the calcium oxide is added as a constituent of an inorganic mixture comprising at least 50% by weight of the calcium oxide.

17. The cold plastic of claim 6, wherein the inorganic pigment is titanium dioxide.
